(19) United States
(12) Patent Application Publication
(10) Pub. No.: US 2010/0174007 A1
(43) Pub. Date: Jul. 8, 2010

(54) Haloneopentyl Bis(ALKYL) Phosphate Ester, Flame Retardant Composition Containing Same and Polyurethane Foam Prepared Therewith

(76) Inventors: Yinzhong Guo, Midland, MI (US); Andrew M. Piotrowski, Yorktown Heights, NY (US); Anantha N. Desikan, Yorktown Heights, NY (US); Sophia Dashevsky, Monroe Township, NJ (US)

Correspondence Address: DILWORTH & BARRESE, LLP, 1000 WOODBURY ROAD, SUITE 405, WOODBURY, NY, 11797, US

(21) Appl. No.: 12/522,027

(22) PCT Filed: Jan. 2, 2008
(86) PCT No.: PCT/US08/00005

§ 371 Date: Jan. 20, 2010

Related U.S. Application Data
(60) Provisional application No. 60/878,479, filed on Jan. 3, 2007.

(51) Int. Cl. C08L 75/04; C07F 9/06; C09K 21/08; C09K 21/12

(52) U.S. Cl. 521/155; 568/14; 252/609

(57) ABSTRACT

A haloneopentyl dialkylphosphate ester possesses the general formula wherein each X is Br or Cl, provided at least two of X are Br, and R¹ and R² each independently is alkyl of up to 12 carbon atoms.

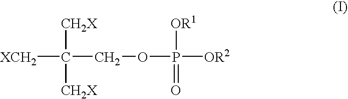

### BACKGROUND OF THE INVENTION

This invention relates to halogenated alkyl phosphate esters, in particular haloneopentyl bis(alkyl)phosphate esters, to flame retardant compositions containing such esters and to polyurethane foams containing such flame retardant compositions.

Haloneopentyl bis(alkyl)phosphate esters are generically known, e.g., from U.S. Pat. Nos. 3,287,266, 3,324,205 and 3,830,886. These phosphate esters find use, inter alia, as flame retardants for polyurethane foams.

It is also known to incorporate non-halogenated flame retardants, e.g., triaryl phosphate esters, alkylated triaryl phosphate esters, oligomeric phosphate esters, melamine, melamine derivatives, and the like, in various resins including polyurethane foams. Non-halogenated phosphate ester flame retardants have the advantage of posing fewer environmental and/or safety risks compared with halogenated flame retardants. However, non-halogenated phosphate ester flame retardants are generally not as effective as equivalent weight amounts of halogenated flame retardants such as the aforementioned haloneopentyl bis(alkyl)phosphate esters. It is therefore a common practice to combine a non-halogenated phosphate ester flame retardant with one of the halogenated variety in order to augment the flame retardancy performance of the former.

It has now been discovered that the flame retardancy performance of a non-halogenated flame retardant such as those aforementioned can be improved beyond the merely additive by admixture with at least one haloneopentyl bis(alkyl)phosphate ester of the type hereinafter described.

### SUMMARY OF THE INVENTION

In accordance with the invention, a haloneopentyl bis(alkyl)phosphate ester is provided having the general formula

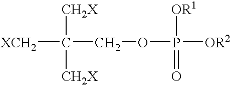

Wherein each X is Br or Cl, provided, at least two of X are Br; and, R¹ and R² each independently is alkyl of from 3 to 6 carbon atoms.

Unlike other halogenated phosphate ester flame retardants of the prior art, the foregoing haloneopentyl bis(alkyl)phosphate ester is non-mutagenic according to the Ames test for mutagenicity.

Further in accordance with the invention, a flame retardant composition is provided which comprises at least one of the foregoing haloneopentyl bis(alkyl)phosphate esters as a first flame retardant and, as a second flame retardant, at least one non-halogenated flame retardant.

Even where the first flame retardant constitutes a minor amount by weight of the flame retardant composition, its contribution to the flame retardancy performance of the composition is greater than merely additive. The flame retardant performance of such a mixed flame retardant composition can be made to closely approximate that of an equal weight amount of flame retardant made up entirely of haloneopentyl bis(alkyl)phosphate ester flame retardant, such being entirely unexpected.

Thus, in accordance with the invention, flame retardant compositions can be provided which contain a major amount of the more environmentally acceptable and generally safer but less effective non-halogenated flame retardant and a minor amount of the more effective halogenated neopentyl bis(alkyl)phosphate ester while achieving a level of flame retardancy performance that is closer to that of an equal weight of the latter than an equal weight of the former.

As used herein in its generic sense and in the appended claims, the term “polyurethane” shall be understood to include and/or be interchangeable with “polyisocyanurate”.

### DESCRIPTION OF THE PREFERRED EMBODIMENTS

The haloneopentyl bis(alkyl)phosphate ester of this invention, useful, inter alia, as a flame retardant by itself or in combination with one or more flame retardants for resins in general and polyurethane foams in particular, possesses the general formula

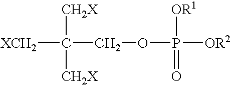

wherein each X is Br or Cl, provided, at least two of X, and preferably, all three of X, are Br; and, R¹ and R² each independently is alkyl, preferably branched alkyl, of up to 12 carbons, and preferably from 3 to 8 carbons, e.g., propyl, isopropyl, n-butyl, isobutyl, sec-butyl, tert-butyl, n-pentyl, isopentyl, 2-methylbutyl, n-hexyl, isohexyl, 2-methylhexyl, 2-ethylhexyl, and the like.

The haloneopentyl bis(alkyl)phosphate ester herein can be readily obtained by reacting a haloneopentyl alcohol of the general formula

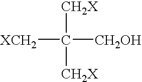

wherein X has the aforestated meaning with at least an equimolar amount, and preferably a significant molar excess, e.g., from about a 1.5 to about 2 molar excess, of phosphorus oxychloride, POCl₃, to provide the corresponding haloneopentyl dichlorophosphate

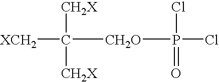

which, following its recovery, is reacted in at least a 1:2 molar ratio, and preferably in at least a 1:2.1 or greater molar ratio, with an alkanol or mixture of alkanols R¹ wherein R¹ has the aforestated meanings to provide the haloneopentyl bis(alkyl)phosphate ester of the invention.

Thus, e.g., tribromoneopentyl bis(isobutyl)phosphate ester can be prepared in accordance with the following sequence of reactions:

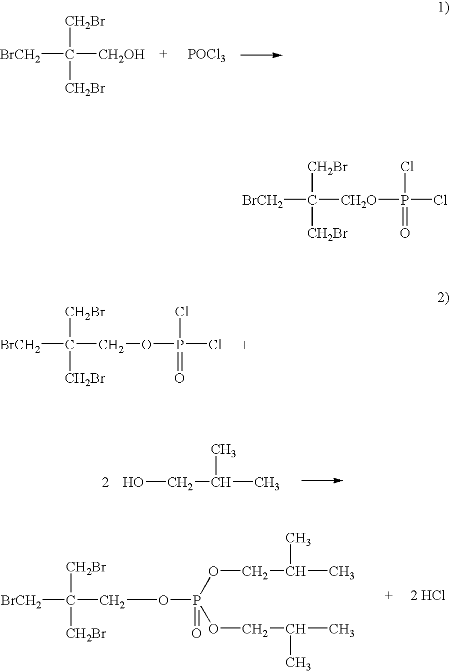

In a similar manner, other haloneopentyl bis(alkyl)phosphate esters of the invention can be obtained such as dibromochloroneopentyl bis(isobutyl)phosphate, trichloroneopentyl bis(isobutyl)phosphate, tribromoneopentyl bis(2-ethylhexyl)phosphate, and the like.

When the haloneopentyl bis(alkyl)phosphate phosphate ester is employed in admixture with one or more other flame retardants, it is advantageous to employ as such additional flame retardant(s) one or more non-halogenated flame retardants due, as noted above, to their generally fewer environmental and/or safety risks compared to many of the halogenated flame retardants, the haloneopentyl bis(alkyl)phosphate ester of the invention excepted.

Especially useful non-halogenated flame retardants are the triaryl phosphates and alkylated triaryl phosphates disclosed, e.g., in U.S. Pat. No. 4,696,952 and U.S. Patent Application 2006/0208238, the oligomeric phosphate esters disclosed, e.g., in U.S. Pat. Nos. 6,861,452 and 7,122,135, and the melamine and melamine derivatives disclosed, e.g., in U.S. Pat. Nos. 4,143,029, 4,317,889 and 4,963,593. The entire contents of the aforementioned U.S. patents and U.S. patent application are incorporated by reference herein.

A mixed flame retardant composition according to the invention preferably contains a major amount by weight of one or more non-halogenated flame retardants, e.g., any of those mentioned above. In general, the flame retardant composition will contain from about 55 to about 85 weight percent, and optionally up to about 95 weight percent, and advantageously from about 65 to about 75 weight percent, and optionally up to about 90 weight percent, of non-halogenated flame retardant, the balance of the composition being made up of at least one haloneopentyl bis(alkyl)phosphate ester of the invention.

The haloneopentyl bis(alkyl)phosphate esters of the invention, and mixed flame retardant compositions containing them, are intended to be added to polyurethane foam in a flame retardant-effective amount. For many polyurethane foams, this amount can vary from about 1 to about 20, and preferably from about 5 to about 15, parts by weight of the foam-forming formulation.

The haloneopentyl bis(alkyl)phosphate esters herein and flame retardant compositions containing them are particularly useful for incorporation in low density flexible polyurethane foams, e.g., those possessing a density of not greater than about 1.4 lb./ft³ and preferably not greater than about 1.2 lb./ft³.

The following examples are illustrative of the haloneopentyl bis(alkyl)phosphate ester, mixed flame retardant composition and flame retarded polyurethane foam of the present invention.

Evaluation of the polyurethane foam samples included measurement of their airflow, density, indentation-force deflection and compression set properties.

Air flow is a measure of cross-linking (or for a flexible polyurethane foam, a lack of cross-linking) according to ASTM D 3574-03, Test G.

Indentation-force deflection measures the load necessary to deflect a polyurethane foam by a stated percent of its original height following a modified ASTM test B 3574-03. A disk having a diameter of 203 mm is pressed into flexible foam until the foam is compressed with the resulting value being expressed as a percent of the original height. The foam blocks tested were 15 by 15 by 4 inches.

Compression set measures the loss of resiliency when a polyurethane foam is held under compression following a modified ASTM test D 3574-03. This evaluation compresses the foam to 90% of its unrestrained height for 22 hours at 70° C. The loss of resiliency, measured from the failure of the foam to spring back to its pre-test height, is reported as a percent of the pre-test height of the foam measured 50 minutes after compression is removed.

LAB Color Scale

In 1931, the Commission Internationale d'Eclairage (CIE) developed a color model that displays every color perceived by the human eye. In 1976, this model was updated and refined in order to create the CIE Lab color system. Unlike RGB colors that are screen-dependent and CMYK colors that vary with printer, ink and paper characteristics, CIE Lab colors are device-independent. Therefore, the visual characteristics of these colors remain consistent on monitors, printers and scanners.

Photoshop CS2 software was used to separate “L”, “a” and “b” components of high resolution digital images of foam samples taken under standard light conditions. In order to ensure high precision, all images always included 3 color standards.

In Photoshop, the Lab mode consists of three color channels. The first channel is Lightness (L). The Lightness component, otherwise known as luminosity, can range from 0 to 100. A Lightness value of 0 equals black and a value of 100 equals white. Thus, the higher the value, the more vivid the color. The other two channels, “a” and “b”, represent color ranges. The “a” channel contains colors ranging from green to red and the “b” channel contains colors ranging from blue to yellow. Positive values of “b” represent yellow color. As in the case with luminosity, the higher the value the more vivid the color. Samples with “b” values of <15 appear white. Samples with values of 20-25 appear off-white to light yellow while samples with b values >30 are noticeably yellow.

The ordinary, casual observer is able to differentiate between two colors that are 2-5 units apart.

### Example 1

This example illustrates the preparation of tribromoneopentyl bis(isobutyl) phosphate. ³¹P NMR was used to identify all products. Triphenyl phosphate solution in CDCl₃ was used as a reference.

### A. Preparation of Tribromoneopentyl Dichlorophosphate Intermediate

650 g (2.0 mol) of tribromoneopentyl alcohol was gradually added to a mixture of 614 g (4 mol) POCl₃ and 0.6 g (0.0063 mol) of MgCl₂ in 200 ml of toluene at 80-85° C. over 4 hrs. After this addition, the mixture was heated to 100° C. for over 2 hrs and maintained at this temperature for 3 hrs. The tribromoneopentyl dichlorophosphate intermediate (³¹P NMR: 6.74 ppm) was obtained following removal of toluene solvent and excess POCl₃, and contained 7% weight of di-tribromoneopentyl chlorophosphate (³¹P NMR: 3.99 ppm).

B. Preparation of tribromoneopentyl bis(isobutyl)phosphate ester

296 g (4.0 mol) of isobutanol was added dropwise into the mixture of the foregoing chlorophosphates in toluene (100 ml) at 70-80° C. over 6 hrs. After this addition, the reaction was continued at this temperature for 2 hrs. The temperature was then increased to 100° C. for 1 hour. After removal of solvent and excess isobutanol, the product was dissolved in 200 ml toluene and washed with 5 weight % oxilic acid, water, 5 weight % NaOH, water. The acid number of the final product was 0.008 mgKOH/g, and contained 97 weight % of tribromoneopentyl bis(isobutyl)phosphate (³¹P NMR: −1.47 ppm) and 3 weight % of di-tribromoneopentyl bis(isobutyl)phosphate (³¹P NMR: −2.15 ppm). The final yield was 90 weight %. The 5% weight loss of the product measured by TGA occurred at 200° C.

### C. Purification of Products Mixture Example 1 (B)

The product mixture from Example (B) was purified by passage through a wiped film evaporator to remove odoriferous by-product. The evaporator jacket was set to 120° C. and the condenser to 23° C. More than 80 weight % of odor-free product was recovered.

### Examples 2-6; Comparative Example 1

Test examples of flexible polyurethane foams (nominal densities of 1.0 and 1.8 pounds per cubic foot) were prepared incorporating each of several different flame retardants and evaluated for flammability employing test procedures described in the State of California Department of Consumer Affairs Bureau of Home Furnishings and Thermal Insulation, Technical Bulletin 117 (March 2000), “Requirements, Test Procedure and Apparatus for Testing the Flame Retardance of Resilient Filling Materials Used in Upholstered Furniture”, Sections A and D

The components of the flexible polyurethane foam-forming compositions and their amounts in parts by weight are set forth in Table 1 below:

TABLE 1
Flexible Polyurethane Foam Formulation, 1 lb foam

| | |
|---|---|
| Polyether Polyol Voranol 3136 Dow | 100.0 |
| Flame Retardant | As indicated in |
| | Table 3, infra |
| Water | 5.6 |
| Methylene Chloride | 10 |
| Dabco 33LV/A-1 amine catalyst (Air Products) | 0.20 |
| Silicone surfuctant L-620 (General Electric) | 1.0 |
| Stannous octoate T-10 (Air Products) | 0.72 |
| Toluene diisocyanate (TDI) | 71 |

TABLE 2
Flexible Polyurethane Foam Formulation, 1.8 lb foam

| | |
|---|---|
| Polyether Polyol Voranol 3136 Dow | 100.0 |
| Flame Retardant | As indicated in |
| | Table 3, infra |
| Water | 3.55 |
| Dabco 33LV/A-1 amine catalyst (Air Products) | 0.20 |
| Silicone surfuctant L-620 (General Electric) | 0.8 |
| Stannous octoate T-10 (Air Products) | 0.45 |
| Toluene diisocyanate (TDI) | 47.3 |

The non-halogenated phosphate ester flame retardant t-butylated triphenyl phosphate and the mixture of halogenated flame retardant products of Example 1, tetra-isobutyl-2,2-dichloromethyl-1,3-propylenebis(phosphate), were individually evaluated at differing levels of incorporation in the foregoing polyurethane foam and in combinations of non-halogenated and halogenated compounds employing the Cal. TB 117A flammability evaluation test and Cal. TB 117D smoldering test and the requirements of MVSS 302 standard for foam in automotive applications (described in 49 United States Code of Federal Regulations, Title 49, §571.302).

TABLE 3
Results of Flame Retardancy Performance Evaluation in Flexible Polyurethane Foam,
Cal. TB 117 A and D

| | | | | Cal. TB 117A Test | | |
|---|---|---|---|---|---|---|
| | | Foam | | Unaged, | Aged | |
| | | Characteristics | | (average), | (average), | Cal TB 117D |
| | | Density, | Air Flow, | distance in | distance in | Weight % |
| Example | Flame Retardant(s), amount(s) | 1b/ft³ | ft³/min. | inches | inches | retention |
| Comp. | t-butylated triphenyl phosphate, | 1 | 4.4 | 4.2 | 6.0 | |
| Ex. 1 | 18 phr | | | | | |
| Ex. 2 | Products of Ex. 1 (B), 18 phr | 1 | 6.6 | 3.4 | 3.3 | |
| Ex. 3 | t-butylated triphenyl phosphate, | 1 | 5.7 | 3.3 | 3.6 | |
| | 13.5 phr; products of Ex. 1(B), | | | | | |
| | 4.5phr | | | | | |
| Ex. 3 | t-butylated triphenyl phosphate, | 1 | 5.7 | 3.5 | 3.8 | |
| | 9.8 phr; products of Ex. 1(B), | | | | | |
| | 4.2 phr | | | | | |
| Ex. 4 | t-butylated triphenyl phosphate, | 1 | 5.0 | 3.3 | 3.5 | |
| | 9.8 phr; products of Ex. 1(C), | | | | | |
| | 4.2 phr with 1% antioxidant | | | | | |
| | package | | | | | |
| Ex. 5 | t-butylated triphenyl phosphate, | 1.8 | 3.6 | 2.6 | 4.0 | 95 |
| | 6.0 phr; products of Ex. 1 (C), | | | | | |
| | 2.0 phr | | | | | |

TABLE 4
Flammability Performance, MVSS 302 Test

| | | Density, | Air Flow, | MVSS 302 |
|---|---|---|---|---|
| | | lb/ft³ | ft³/min. | rating |
| Ex. 2 | Products of Ex. 1 (B) before, | 1 | 6.6 | SE |
| | 18 phr | | | |
| Ex. 5 | t-butylated triphenyl | 1.8 | 3.6 | SE |
| | phosphate, 6.0 phr; products | | | |
| | of Ex. 1 (C), 2.0 phr | | | |

TABLE 5
Mechanical Properties of the Foam Samples

| | | | Air | | |
|---|---|---|---|---|---|
| | | Density, | Flow, | Compression | 25% IFD |
| | | 1b/ft³ | ft³/min. | set % | (pounds) |
| Ex. 6 | t-butylated triphenyl | 1 | 5.1 | 19.8 | 31.5 |
| | phosphate, 11.2 phr; | | | | |
| | products of | | | | |
| | Ex. 1(B), 4.8 phr | | | | |

### Table 6: Results of AMES Tests

In each Ames test, a single chemical substance was evaluated in the four standard Salmonella typhimurium tester strains, TA1535, TA1537, TA98, and TA100. Strains TA1535 and TA100 identify mutagens that act via base-pair substitution whereas TA1537 and TA98 identify mutagens capable of causing frameshifts in the DNA. The bacterial strain E. coli WP2uvrA was also included as another sensitive tester strain. Each test was conducted with and without metabolic activation.

The results of the tests are as follows.

| Test Substance | TA1535 | TA1537 | TA98 | TA100 | WP2uvrA |
|---|---|---|---|---|---|
| Phosphoric acid, 3- | − | − | − | + | − |
| bromo-2,2- | | | | | |
| bis(bromomethyl)propyl | | | | | |
| bis[2-chloro-1- | | | | | |
| (chloromethyl)ethyl]ester | | | | | |
| O-tert-Butylphenyl | + | − | − | + | − |
| bis(1,3-dichloro-2- | | | | | |
| propyl)phosphate | | | | | |
| Products of 1(B) | − | − | − | − | − |

Plus sign indicates observed mutagenic effects; minus sign indicates non-mutagenic property.

### Acute Toxicity Results for Product Mixture 1(B)

No rats died after the administration of an oral limit dose of 5000 mg/kg of products from Example 1(B). Clinical signs were minimal and all rats fully recovered by day 3. The acute oral LD50 was greater than 5000 mg/kg.

### Scorch Evaluation

Oven foam aging test followed by spectral color analysis was used as a screening tool to determine scorch potential. Samples were aged at 183° C. for two hours and “b” factor of a “Lab” color scale measured to determine the degree of “yellowness”. The time and temperature for the oven aging were balanced to reflect actual foam production scorch performance.

Scorch test results

| | |
|---|---|
| Comparative Example 1 (halogen-free flame retardant | b = 15 |
| Foam with 16 parts of Fyrol FR2 (halogenated FR) | b = 47 |
| Foam from example 3 | b = 20 |
| Foam from example 4 | b = 18 |

By this criteria, foam with b values of equal or less than 20 are non-scorchy. Foams with b values of 21-30 are essentially non-scorchy while foams with b values of >40 are highly scorched.

The use of various prior art materials as flame retardants for polyurethanes has often resulted in certain disadvantages such as thermal migration, head instability, light instability, hydrolytic instability and foam discoloration. Thus, there is always a demand for a material which will function as a flame retardant in polyurethanes and concurrently will not, by incorporation therein, adversely affect the chemical, physical, and mechanical properties and the appearance of the resultant polyurethane composition. This is particularly true with respect to materials which will function as flame retardants in polyurethanes without scorching or discoloring the resultant polyurethanes compositions. While many of the prior art compounds may function as effective flame retardants in polyurethanes, they may nevertheless adversely affect the color properties of the polyurethanes. This is especially true for highly efficient halogen containing flame retardants.

While the invention has been described in detail in connection with specific embodiments thereof, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Accordingly, the invention is not to be limited by the foregoing description.

1. Haloneopentyl bis(alkyl)phosphate ester of the general formula 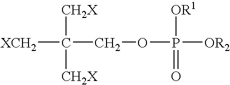
wherein each X is Br or Cl, provided at least two of X are Br; and, R¹ and R² each independently is alkyl of up to 12 carbon atoms.

2. The haloneopentyl bis(alkyl)phosphate ester of claim 1 wherein each X is Br and R¹ and R² each is propyl, isopropyl, n-butyl, isobutyl, sec-butyl, tert-butyl, n-pentyl, isopentyl, 2-methylbutyl, n-hexyl, isohexyl, 2-methylhexyl or 2-ethylhexyl.

3. The haloneopentyl bis(alkyl)phosphate ester of claim 2 which is selected from the group consisting of tribromoneopentyl bis(isobutyl)phosphate ester, dibromochloroneopentyl bis(isobutyl)phosphate, trichchloroneopentyl bis(isobutyl)phosphate, tribromoneopentyl bis(2-ethylhexyl)phosphate and mixtures thereof, said phosphate ester(s) being non-mutagenic according to the Ames test for mutagenicity.

4. The haloneopentyl bis(alkyl)phosphate ester of claim 1 which is non-mutagenic according to the Ames test for mutagenicity.

5. A flame retardant composition comprising at least one haloneopentyl bis(alkyl)phosphate ester of claim 1.

6. A flame retardant composition comprising at least one haloneopentyl bis (alkyl)phosphate ester of claim 4.

7. The flame retardant composition of claim 5 further comprising at least one non-halogenated flame retardant compound.

8. The flame retardant composition of claim 7 wherein the non-halogenated flame retardant compound is selected from the group consisting of triaryl phosphate ester, alkylated triaryl phosphate ester, oligomeric phosphate ester, melamine and melamine derivative.

9. The flame retardant composition of claim 7 wherein the non-halogenated flame retardant comprises from about 55 to about 95 weight percent of the total flame retardant compounds.

10. The flame retardant composition of claim 7 wherein the non-halogenated flame retardant comprises from about 55 to about 85 weight percent of the total flame retardant compounds.

11. The flame retardant composition of claim 7 wherein the non-halogenated flame retardant comprises from about 65 to about 90 weight percent of the total flame retardant compounds.

12. The flame retardant composition of claim 7 wherein the non-halogenated flame retardant comprises from about 65 to about 75 weight percent of the total flame retardant compounds.

13. A polyurethane foam containing the flame retardant composition of claim 5.

14. The polyurethane foam of claim 13 which is a low density flexible polyurethane foam.

15. A polyurethane foam containing the flame retardant composition of claim 7.

16. The polyurethane foam of claim 15 which is a low density flexible polyurethane foam.

17. A polyurethane foam containing the flame retardant composition of claim 9.

18. The polyurethane foam of claim 17 which is a low density flexible polyurethane foam.

19. A polyurethane foam containing the flame retardant composition of claim 10.

20. The polyurethane foam of claim 19 which is a low density flexible polyurethane foam.
